(19) United States
(12) Patent Application Publication
(10) Pub. No.: US 2018/0290501 A1
(43) Pub. Date: Oct. 11, 2018

(54) METHODS AND APPARATUS FOR DETERMINING REMAINING LIFE OF A TIRE BASED ON ROAD VIBRATION DATA AND TIRE TREAD GROOVE DEPTH

(71) Applicant: GM GLOBAL TECHNOLOGY OPERATIONS LLC, Detroit, MI (US)

(72) Inventors: KENNETH L. OBLIZAJEK, TROY, MI (US); JINSHUO ZHU, NOVI, MI (US); CHRISTOPHE A. STIRLEN, MILFORD, MI (US)

(73) Assignee: GM GLOBAL TECHNOLOGY OPERATIONS LLC, Detroit, MI (US)

(21) Appl. No.: 15/481,988

(22) Filed: Apr. 7, 2017

(51) Int. Cl. B60C 11/24; G01M 17/02; G07C 5/08

(52) U.S. Cl. CPC B60C 11/246; G07C 5/0808; G01M 17/025

(57) ABSTRACT

A method for evaluating a vehicle tire is provided. The method obtains, by at least one vehicle onboard motion sensor, vibration data associated with a corner of a vehicle, the vehicle tire being located at the corner; detects an inflation pressure value for the vehicle tire; receives, from a vehicle onboard computer system, tire age data associated with the vehicle tire; calculates remaining tread groove depth for the vehicle tire, based on the vibration data, the inflation pressure data, and the tire age data; and performs a task, based on the remaining tread groove depth for the vehicle tire, wherein the task comprises at least one of: presenting a notification of the remaining tread groove depth to a driver, and setting a code onboard the vehicle, wherein the code is associated with service notifications.

### TECHNICAL FIELD

Embodiments of the subject matter described herein relate generally to determining a remaining useful life of a tire, and more particularly, to using tire and vehicle data parameters to determine tire tread groove depth, which is indicative of the remaining useful life of the tire.

### BACKGROUND

A tire is a ring-shaped vehicle component that covers the rim of a wheel for protection and to enable improved vehicle performance. Tires generally provide traction between the vehicle and a driving surface, while providing a flexible cushion that absorbs shock. Tires mounted on a vehicle affect operation of the vehicle. Tire tread provides a tire its ability to grip the road. Vehicles and tires are engineered with a particular kind of performance in mind, and there is a variety of tread patterns and types that match each kind of intended performance. Various types of tire tread are designed and used to maximize fuel economy and to permit particular vehicles to corner tighter, accelerate more smoothly, and brake quickly.

When not impacted by damage other than normal wear and tear, the lifespan of a tire may be months or years. Because vehicle owners do not have to replace tires more often, a user may forget and/or unnecessarily delay visually inspecting the tires to determine whether tire replacement is appropriate. This may result in a user driving a vehicle with tires that are worn beyond recommended limits, thereby impairing performance of the vehicle.

Accordingly, it is desirable to provide some type of notification to a user regarding vehicle tire status. Furthermore, other desirable features and characteristics will become apparent from the subsequent detailed description and the appended claims, taken in conjunction with the accompanying drawings and the foregoing technical field and background.

### BRIEF SUMMARY

Certain embodiments of the present disclosure provide a method for evaluating a vehicle tire. The method obtains, by at least one vehicle onboard motion sensor, vibration data associated with a corner of a vehicle, the vehicle tire being located at the corner; detects an inflation pressure value for the vehicle tire; receives, from a vehicle onboard computer system, tire age data associated with the vehicle tire; calculates remaining tread groove depth for the vehicle tire, based on the vibration data, the inflation pressure data, and the tire age data; and performs a task, based on the remaining tread groove depth for the vehicle tire, wherein the task comprises at least one of: presenting a notification of the remaining tread groove depth to a driver, and setting a code onboard the vehicle, wherein the code is associated with service notifications.

Some embodiments provide a system for evaluating a vehicle tire mounted at a corner of a vehicle. The system includes a system memory element, configured to store profile data associated with the vehicle tire, wherein the profile data comprises at least tire age data; a plurality of vehicle onboard sensors, configured to obtain inflation pressure data for the vehicle tire and vibration data associated with the corner of the vehicle; a display device, configured to present notifications onboard the vehicle; at least one processor communicatively coupled to the system memory element, the display device, the user interface, and the plurality of vehicle onboard sensors, the at least one processor configured to calculate remaining tread groove depth for the vehicle tire, based on the vibration data, the inflation pressure data, and the tire age data; and perform a task, based on the remaining tread groove depth, wherein the task comprises at least one of: initiating presentation of a notification of the remaining tread groove depth to a driver, via the display device onboard the vehicle, and setting code onboard the vehicle, wherein the code is associated with service notifications.

Some embodiments provide a non-transitory, computer-readable medium containing instructions thereon, which, when executed by a processor, perform a method. The method calculates, by a vehicle onboard computer system, remaining life of a tire mounted on a vehicle, based on vibration data associated with the tire, inflation pressure of the tire, and age of the tire; and performs a task, based on the remaining tread groove depth for the vehicle tire, wherein the task comprises at least one of: presenting a notification of the remaining tread groove depth to a driver, and setting a code onboard the vehicle, wherein the code is associated with service notifications.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a functional block diagram of a tire evaluation system onboard a vehicle, in accordance with various embodiments;

FIG. 2 is a diagram of a vehicle tire, in accordance with various embodiments;

FIG. 3 is a flow chart that illustrates an embodiment of a process for initializing a tire evaluation system, in accordance with various embodiments;

FIG. 4 is a flow chart that illustrates an embodiment of a process for evaluating a vehicle tire, in accordance with various embodiments; and

FIG. 5 is a flow chart that illustrates an embodiment of a process for calculating a remaining tread groove depth for a tire, in accordance with various embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The present disclosure relates to methods and apparatus for evaluating and reporting the condition and remaining life of vehicle tires, which includes determining an existing amount of tire tread (e.g., a tire tread mass value, remaining anti-skid (RAS), remaining tread groove depth) of the vehicle tires. The tread mass, or in other words, the amount of tread or remaining tread groove depth, on each tire provides a clear indication of the remaining life of each tire.

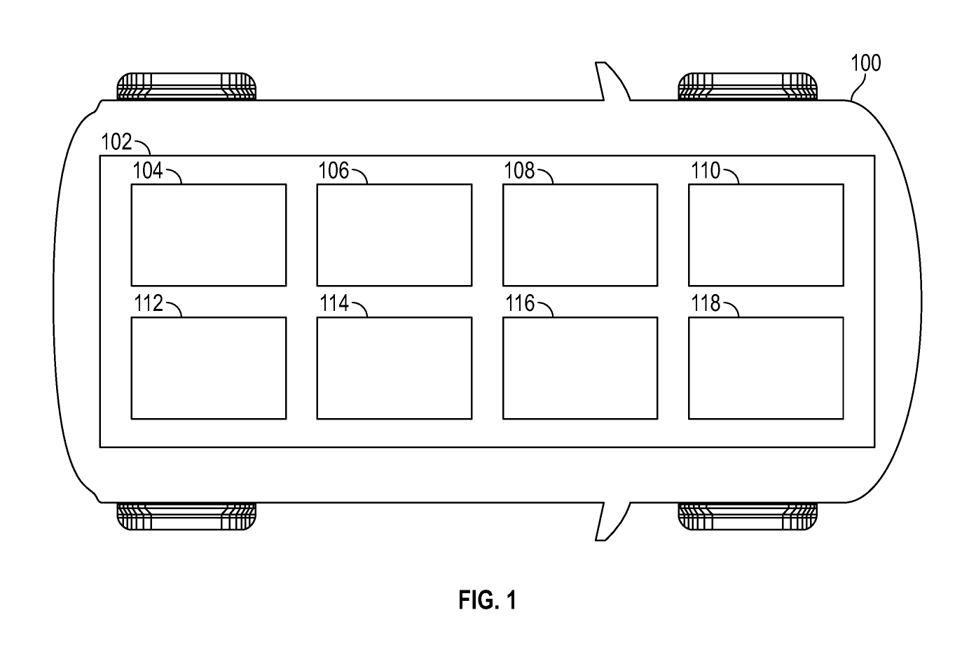

FIG. 1 is a functional block diagram of a tire evaluation system 102 onboard a vehicle 100, in accordance with various embodiments. The vehicle 100 may be implemented by any type of vehicle that uses tires, including but not limited to, any one of a number of different types of types of automobiles (cars, trucks, motorcycles, sport-utility vehicles, vans, etc.), recreational vehicles (all-terrain vehicles, four-wheelers, campers, etc.), military vehicles (Humvees, trucks, etc.), rescue vehicles (fire engines, ladder trucks, police cars, emergency medical services trucks and ambulances, etc.), and the like. The tire evaluation system 102 is implemented onboard the vehicle 100 to determine a condition of the vehicle tires, and in some embodiments, to provide a user with a notification of the determined tire condition.

The tire evaluation system 102 generally includes at least one processor 104; a system memory element 106; a user interface 108; a plurality of vehicle onboard sensors 110; a tire tread calculation module 112; a notification module 114; a network interface module 116; and a driver information center (DIC) 118. These elements and features of the tire evaluation system 102 may be operatively associated with one another, coupled to one another, or otherwise configured to cooperate with one another as needed to support the desired functionality—in particular, determining the condition and/or remaining life of a vehicle tire, as described herein. For ease of illustration and clarity, the various physical, electrical, and logical couplings and interconnections for these elements and features are not depicted in FIG. 1. Moreover, it should be appreciated that embodiments of the tire evaluation system 102 will include other elements, modules, and features that cooperate to support the desired functionality. For simplicity, FIG. 1 only depicts certain elements that relate to the tire evaluation techniques described in more detail below.

The at least one processor 104 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 104 may be realized as one or more microprocessors, controllers, microcontrollers, or state machines. Moreover, the at least one processor 104 may be implemented as a combination of computing devices, e.g., a combination of digital signal processors and microprocessors, a plurality of microprocessors, one or more microprocessors in conjunction with a digital signal processor core, or any other such configuration.

The at least one processor 104 communicates with system memory 106. The system memory 106 may be used to store tire age data, tire profile data, tire status data (e.g., tire tread mass, remaining tread groove depth, remaining anti-skid (RAS), vibration data, inflation pressure data), or the like. The system memory 106 may be realized using any number of devices, components, or modules, as appropriate to the embodiment. In practice, the system memory 106 could be realized as RAM memory, flash memory, EPROM memory, EEPROM memory, registers, a hard disk, a removable disk, or any other form of storage medium known in the art. In certain embodiments, the system memory 106 includes a hard disk, which may also be used to support functions of the at least one processor 104. The system memory 106 can be coupled to the at least one processor 104 such that the at least one processor 104 can read information from, and write information to, the system memory 106. In the alternative, the system memory 106 may be integral to the at least one processor 104. As an example, the at least one processor 104 and the system memory 106 may reside in a suitably designed application-specific integrated circuit (ASIC).

The user interface 108 may include or cooperate with various features to allow a user to interact with the tire evaluation system 102. Accordingly, the user interface 108 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the tire evaluation system 102. For example, the user interface 108 could be manipulated by an operator to request tire status data, to enter tire age and/or tire profile data, to reset the tire age data when new tires are installed on the vehicle 100, or the like.

The plurality of vehicle onboard sensors 110 includes at least one tire pressure sensor configured to provide inflation pressure data associated with one or more tires mounted to the vehicle 100. The plurality of vehicle onboard sensors 110 also includes vehicle motion sensors that are configured to detect vibration data associated with each corner of the vehicle 100, for use in evaluating a condition or status of each of the tires on the vehicle 100. Vehicle motion sensors may be implemented using any of the following, without limitation: one or more accelerometers, one or more velocity sensors, and one or more relative displacement sensors. In certain embodiments, the vehicle motion sensors may be new, additional sensors that are newly-installed on the vehicle 100 dedicated to the purpose of evaluating the tires on the vehicle 100. In some embodiments, the vehicle motion sensors may be implemented using existing sensors that are already part of existing systems operating onboard the vehicle 100. In this scenario, existing vehicle motion sensors may be used for tire evaluation purposes in addition to performing functionality associated with another system onboard the vehicle 100.

The tire tread calculation module 112 uses vibration data associated with each corner of the vehicle, and thus associated with a tire mounted to each respective corner of the vehicle, to calculate remaining tread groove depth. In certain exemplary embodiments, the accelerometers may be positioned on a knuckle or control arm near a corner of the vehicle 100, where acquisition of vibration data occurs. Vibration data is acquired by the motion sensors by first determining whether the vehicle 100 is operating on a road that has the proper vibration characteristics. The tire evaluation system 102 excludes roads with a high level of anomalies, (i.e., roads that are uneven or “bumpy”), and considers those roads that are adequate for obtaining vibration data useful in determining a resonant frequency. The plurality of vehicle onboard sensors 110 then samples the vibration data for a period of time. In exemplary embodiments of the tire evaluation system 102, the plurality of vehicle onboard sensors 110 is implemented using one or more accelerometers, which generate an output of voltage versus time, and wherein the output voltage is proportional to an acceleration value. The tire evaluation system 102 captures and averages these acceleration values and then performs a frequency spectral view of the data to identify the resonant frequency. The tire tread calculation module 112 then uses the identified resonant frequency to calculate a remaining tread groove depth for each tire of the vehicle 100. The calculated remaining tread groove depth may be used to determine the remaining life of the tire, which may also be referred to as a status of the tire or the “health” of the tire.

The notification module 114 is configured to provide notifications, alerts, and reporting to a user regarding tire status data. This tire status data may include remaining tread groove depth, a tire tread mass value, remaining tire life, or other data associated with the condition of a tire mounted on the vehicle 100. The notification module 114 cooperates with the network interface module 116 to provide email alerts, text messaging alerts, reports provided according to a weekly or monthly schedule, or the like. In certain embodiments, the notification module 114 may cooperate with the network interface module 116 to transmit tire condition data to a remote server for storage for future reporting. The notification module 114 may also cooperate with the driver information center (DIC) 118 to present notifications onboard the vehicle 100. Such alerts may include a lighting up an icon on a dashboard of the vehicle 100, presenting one or more graphical elements via a display element onboard the vehicle, activating a chime or other audio alert, or the like.

In practice, the tire tread calculation module 112 and/or the notification module 114 may be implemented with (or cooperate with) the at least one processor 104 to perform at least some of the functions and operations described in more detail herein. In this regard, the tire tread calculation module 112 and/or the notification module 114 may be realized as suitably written processing logic, application program code, or the like.

The network interface module 116 is suitably configured to communicate data between the tire evaluation system 102 and one or more remote servers and/or one or more devices (e.g., smartphones, tablet computers, laptop computers) compatible with wireless (e.g., cellular and/or WLAN) communication protocols. The network interface module 116 generally operates cooperatively with the notification module 114 to provide tire status data, including remaining life of a tire, remaining tread groove depth for a tire, one or more tire tread mass values, alerts and messaging that provides tire status data, or the like.

In certain embodiments, the network interface module 116 is suitably configured to connect to a wireless network for the transmission of signals from the tire evaluation system 102. In some embodiments, the network interface module 116 transmits data via a WLAN network that is compatible with an IEEE 802.11 standard, and in other embodiments, the network interface module 116 may connect to an ad-hoc network, a Bluetooth network, a personal area network (PAN), or the like. In certain embodiments, the network interface module 116 is implemented as an onboard vehicle communication or telematics system, such as an OnStar® module commercially marketed and sold by the OnStar® corporation, which is a subsidiary of the assignee of the instant Application, the General Motors Company, currently headquartered in Detroit, Mich. In embodiments wherein the network interface module 116 is an OnStar® module, an internal transceiver may be capable of providing bi-directional mobile phone voice and data communication, implemented as Code Division Multiple Access (CDMA). In some embodiments, other 3G technologies may be used to implement the network interface module 116, including without limitation: Universal Mobile Telecommunications System (UMTS) wideband CDMA (W-CDMA), Enhanced Data Rates for GSM Evolution (EDGE), Evolved EDGE, High Speed Packet Access (HSPA), CDMA2000, and the like. In some embodiments, 4G technologies may be used to implement the network interface module 116, alone or in combination with 3G technologies, including without limitation: Evolved High Speed Packet Access (HSPA+), Long Term Evolution (LTE) and/or Long Term Evolution-Advanced (LTE-A).

The driver information center (DIC) 118 generally indicates a dashboard that includes a plurality of notification icons or lights that may be illuminated to provide alerts and other vehicle-specific information to an operator of the vehicle 100. In certain embodiments, the DIC 118 may provide chimes, buzzers, bells, or other audio notifications in addition to, or separate and distinct from, any light-up icon on the dashboard of the vehicle 100. The DIC 118 generally operates cooperatively with the notification module 114 to notify an operator of the vehicle 100 of various tire statuses. For example, a notification icon or light may activate when the remaining life of one or more tires on the vehicle 100 is below a particular threshold. As another example, a chime or buzzer may activate in combination with the notification icon or light when the remaining life of one or more tires on the vehicle 100 is below a second, even lower threshold. In a third example, a notification icon may be activated to indicate that a remaining tread groove depth of one or more of the tires mounted on the vehicle 100 is “okay”.

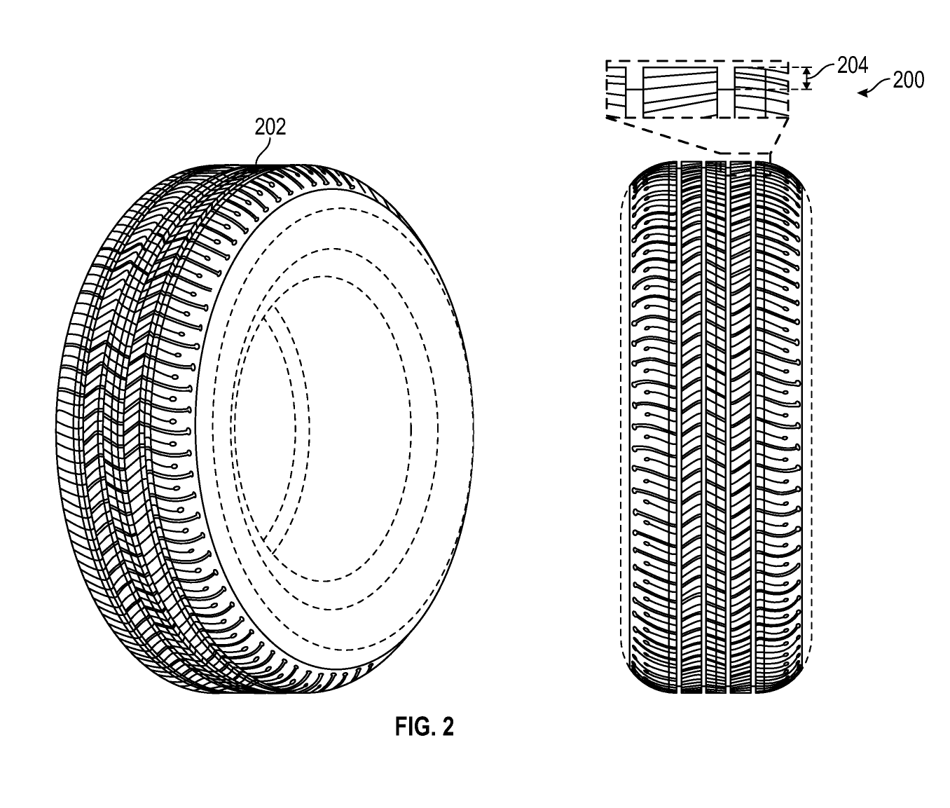

FIG. 2 is a diagram of a vehicle tire 200, in accordance with the disclosed embodiments. As shown, the ring-shaped vehicle tire 200 includes surrounding tire tread 202, which assists in gripping the road during operation of a vehicle. The tire tread 202 includes a tread depth 204 which indicates a remaining life of the vehicle tire 200. As the vehicle tire 200 is used, the tread depth 204 decreases, and the vehicle tire 200 approaches a point of minimal tread depth. When the tread depth 204 is very low or at a minimum usable level, the vehicle tire 200 requires replacement with a second vehicle tire that includes a high level of tread depth 204, and therefore is associated with a lengthy usable life. In other words, a high level of tread depth 204 generally means that the vehicle tire 200 possesses a longer remaining life. As described herein, an evaluation of the tire 200 includes an evaluation of the tire tread 202 and a remaining groove depth of the tire tread 202, which indicates a remaining life of the tire 200.

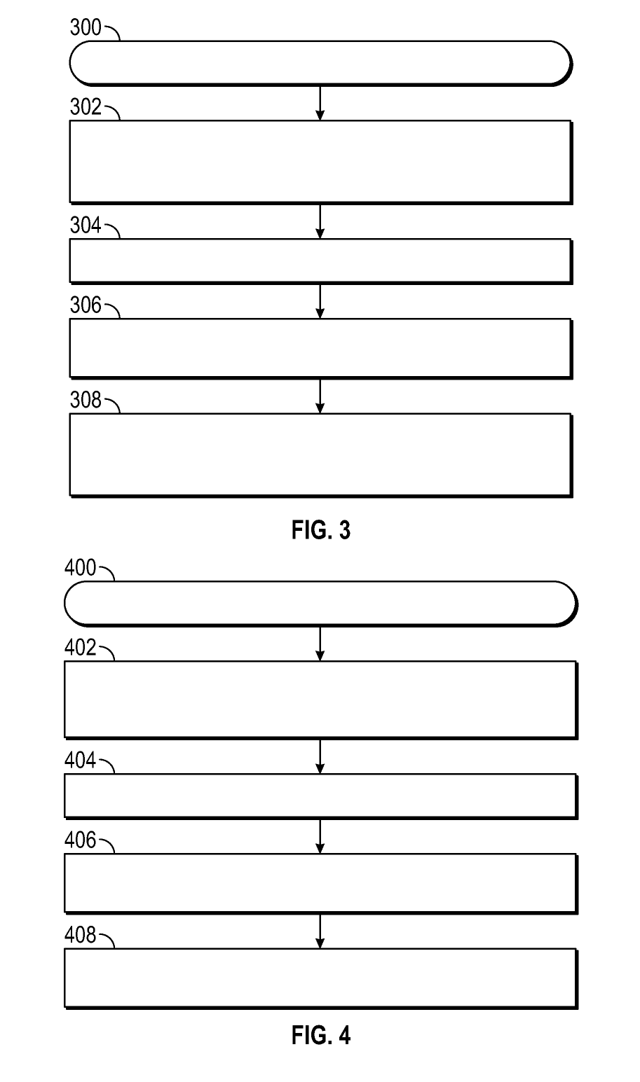

FIG. 3 is a flow chart that illustrates an embodiment of a process 300 for initializing a tire evaluation system. First, the process 300 establishes a communication connection with existing motion sensors and/or positions motion sensors onboard a vehicle (step 302). In some embodiments, the process 300 creates a connection from which to receive data provided by motion sensors that have already been incorporated into the vehicle hardware for a purpose other than providing data to a tire evaluation system (see FIG. 1). In other embodiments, the process 300 may incorporate new vehicle motion sensors onboard the vehicle, and establish a communication connection to the new motion sensors. Alternative embodiments of the process 300 may establish a communication connection to a combination of existing, multi-purpose vehicle motion sensors and new, single-purpose vehicle motion sensors dedicated to tire evaluation.

Next, the process 300 stores tire profile data and tire age data (step 304). Tire profile data may include, without limitation tire characterization data, such as the expected change in frequency per unit groove depth, the change in frequency per unit pressure, and a per unit usage value. Tire age data may be a quantity of days, weeks, months, or years reflecting the length of time that begins upon installation of the new tire on the vehicle. When the tire is an old or used tire, the tire age data may be a length of time that begins at a production date of the tire or a date that the tire was first installed or used on any other vehicle. The process 300 also receives tire age reset data when one or more tires are replaced (step 306). Here, the process 300 stores a new tire age associated with the new tire itself, thereby facilitating accurate calculations during evaluation of the new tire.

Next, the process 300 sets intervals for automatic tire evaluation and/or activates tire evaluation upon user request (step 308). Tire evaluation may be performed according to a timed interval schedule or when the evaluation system receives a request for tire status data. Here, the process 300 configures and stores a timed interval schedule and activates tire evaluation method steps according to the timed interval schedule. In other embodiments, the process 300 receives requests for tire status data, and activates the tire evaluation method steps in response to a received request. Certain embodiments of the process 300 use a combination of a timed interval schedule and requests to activate tire evaluation.

FIG. 4 is a flow chart that illustrates an embodiment of a process 400 for evaluating a vehicle tire. For ease of description and clarity, it is assumed that this example begins by obtaining, by at least one vehicle onboard motion sensor, vibration data associated with the corner of a vehicle, the vehicle tire being located at the corner (step 402). Vibration data is acquired by vehicle motion sensors, which are described with regard to FIG. 1. Vibration data includes vehicular vibrations attributable to suspension actions proximate to key tire modes (e.g., first radial mode at approximately 60-120 Hz), dependent upon the particular vehicle tire.

Next, the process 400 detects an inflation pressure value for the vehicle tire (step 404). In certain embodiments, the process 400 detects the inflation pressure value using a tire pressure sensor. In some embodiments, however, the process 400 detects the inflation pressure value by detecting a number of tire revolutions per unit travel distance for the vehicle tire and determining the inflation pressure value associated with the vehicle tire, based on the number of tire revolutions per unit travel distance.

The process 400 then receives, from a vehicle onboard computer system, tire age data associated with the vehicle tire (step 406). Here, the process 400 may perform a lookup in the vehicle onboard computer system memory, or receive a pushed data transmission from the vehicle onboard computer system. Tire age data may be a quantity of days, weeks, months, or years reflecting the length of time that begins upon installation of the new tire on the vehicle. For used tires, the tire age data may be a length of time that begins at a production date of the tire or a date that the tire was first installed or used on any other vehicle. Tire age data is reset when the particular tire in question is replaced.

The process 400 then calculates remaining tread groove depth for the vehicle tire, based on the vibration data, the inflation pressure data, and the tire age data (step 408). The remaining tread groove depth indicates the remaining anti-skid (RAS), or in other words, the remaining useful life of the vehicle tire. The vehicle tire is capable of operating safely and enabling a particular degree of performance for the vehicle on which the tire is mounted, when the tire tread is within a set of predetermined limits. Here, the process 400 calculates remaining tread groove depth, which may be used to provide a notification of “tire status” to the vehicle operator. Further, the process 400 considers variables which may cause error in the calculation of tire tread groove depth value. Such variables include the inflation pressure of the tire and the age of the tire. The process 400 extracts these variables during calculation of the remaining tread groove depth in order to increase the accuracy of the calculation.

Once the process 400 has calculated the remaining tread groove depth for the vehicle tire (step 408), the process 400 performs a task based on the remaining tread groove depth for the vehicle tire. In exemplary embodiments of the present disclosure, the task comprises at least one of: (i) presenting a notification of the remaining tread groove depth to a driver, and (ii) setting a code onboard the vehicle, wherein the code is associated with service notifications.

In the first example, the process 400 may present a visual and/or audio notification of the remaining tread groove depth using a display device, driver information center (DIC), or other notification hardware onboard the vehicle. In other embodiments, the process 400 transmits the notifications using a vehicle onboard telematics unit, such that a user can receive a notification of the remaining tread groove depth via email, text message, website, or the like. In the second example, the process 400 may set, onboard the vehicle, a code that is associated with service notifications. Here, the process 400 sets a code, flag, or condition by transmitting the code to an appropriate electronic control unit (ECU) onboard the vehicle via a vehicle communication system (e.g., a controller area network (CAN) bus). In this example, the code is used by the ECU to set a flag to indicate that service is required for one or more functions associated with the ECU. Service technicians extract and/or read any set codes, flags, or conditions associated with each ECU onboard the vehicle, to determine appropriate maintenance or service activities appropriate to the code.

To perform the task onboard the vehicle, the process 400 may make a decision as to which task to perform, or the process 400 may receive instructions associated with which task to perform. In other words, the decision as to which task to perform may be determined by the vehicle onboard computer system or by a computer system external to the vehicle. In embodiments where the decision is made externally to the vehicle, the process 400 wirelessly transmits the remaining tread groove depth to an external computer system, receives one or more instructions from the computer system based on the remaining tread groove depth, and performs the task in response to receiving the one or more instructions.

In embodiments where the decision is made onboard the vehicle, the process 400 may identify the appropriate task based on one calculated remaining tread groove depth value. In this case, the process 400 may perform a lookup in system memory of the vehicle onboard computer system to correlate the calculated remaining tread groove depth value to an appropriate task. In some embodiments, the process 400 may identify the appropriate task based on a plurality of calculated remaining tread groove depth values. In this case, the process 400 may store a plurality of remaining tread groove depth values in a memory element of the vehicle onboard computer system, analyze the plurality of remaining tread groove depth values, and identify a correlated vehicle action based on the analysis, wherein the task comprises the correlated vehicle action.

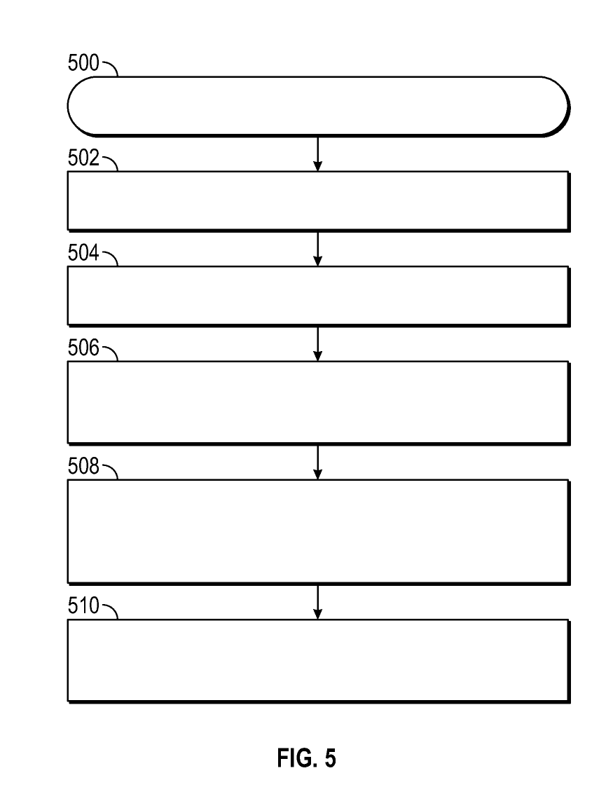

FIG. 5 is a flow chart that illustrates an embodiment of a process 500 for calculating a remaining tread groove depth for a tire. First, the process 500 averages obtained vibration data (step 502), and then the process 500 fits the average vibration data to preferred weighted shapes, to create a smooth curve (i.e., a smooth, fitted shape) (step 504). The process 500 then extracts a resonant frequency from at least one of a fitted undamped resonant frequency and a damped resonant frequency of the smooth, fitted response shape (step 506). Here, the process 500 takes the obtained vibration data and translates the vibration data into the frequency domain. The result of this operation presents a spectrum showing acceleration as a function of frequency. In certain embodiments, the process 500 calculates the resonant frequency (f₀) using the following equations:

$$\frac{( {β}_{1} + {β}_{2} s )}{( {S}^{m} ( {S}^{2} + {ζω}_{0} S + {ω}_{0}^{2} ) )} , m = 1 , \\ {ω}_{0} = 2 π {f}_{0} , s = i ω , {β}_{1} , {β}_{2} and ζ are scalars , and i = sqrt ( - 1 ) .$$

Next, the process 500 uses an equation comprising a first quantity of the resonant frequency, a second quantity of the inflation pressure value, a third quantity of tire characterization data, and a fourth quantity of tire usage data (step 508). Here, the third quantity includes multiple parameters (e.g., pressure sensitivity, frequency sensitivity, aging sensitivity, or the like). In certain embodiments of step 508, the process 500 uses a linear equation comprising each of the quantity values. In other embodiments, the process 500 may use a non-linear equation to determine the first quantity, the second quantity, the third quantity, and the fourth quantity. The process 500 then determines the remaining tread groove depth based on the first quantity, the second quantity, the third quantity, and the fourth quantity (step 510). Here, the process 500 determines an amount of the vibration data that may be directly attributable to inflation pressure of the tire, and the age of the tire, such that these factors may be extracted from the calculation of the remaining tread groove depth of the tire. Thus, the process 500 calculates a more accurate remaining tread groove depth value that is unaltered by the variables that produce error.

The various tasks performed in connection with processes 300-500 may be performed by software, hardware, firmware, or any combination thereof. For illustrative purposes, the following description of processes 300-500 may refer to elements mentioned above in connection with FIGS. 1-2. In practice, portions of processes 300-500 may be performed by different elements of the described system. It should be appreciated that processes 300-500 may include any number of additional or alternative tasks, the tasks shown in FIGS. 3-5 need not be performed in the illustrated order, and each of the processes 300-500 may be incorporated into one or more comprehensive procedures or processes having additional functionality not described in detail herein. Moreover, one or more of the tasks shown in FIGS. 3-5 could be omitted from embodiments of the processes 300-500 as long as the intended overall functionality of each process remains intact.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. A module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for evaluating a vehicle tire, the method comprising:
obtaining, by at least one vehicle onboard motion sensor, vibration data associated with a corner of a vehicle, the vehicle tire being located at the corner;
detecting an inflation pressure value for the vehicle tire;
receiving, from a vehicle onboard computer system, tire age data associated with the vehicle tire;
calculating remaining tread groove depth for the vehicle tire, based on the vibration data, the inflation pressure data, and the tire age data; and
performing a task, based on the remaining tread groove depth for the vehicle tire, wherein the task comprises at least one of:
presenting a notification of the remaining tread groove depth to a driver, and
setting a code onboard the vehicle, wherein the code is associated with service notifications.

2. The method of claim 1, further comprising:
wirelessly transmitting the remaining tread groove depth to an external computer system; and
receiving one or more instructions from the computer system based on the remaining tread groove depth;
wherein the task is performed by the vehicle onboard computer system in response to receiving the one or more instructions.

3. The method of claim 1, further comprising:
storing a plurality of remaining tread groove depth values in a memory element of the vehicle onboard computer system, wherein the plurality of remaining tread groove depth values comprises the remaining tread groove depth;
performing an analysis of the plurality of remaining tread groove depth values;
identifying a correlated vehicle action based on the analysis, wherein the task comprises the correlated vehicle action.

4. The method of claim 1, wherein detecting an inflation pressure value further comprises detecting the inflation pressure value using a tire pressure sensor.

5. The method of claim 1, wherein detecting an inflation pressure value further comprises:
detecting a number of tire revolutions per unit travel distance for the vehicle tire; and
determining the inflation pressure value associated with the vehicle tire, based on the number of tire revolutions per unit travel distance.

6. The method of claim 1, wherein the vehicle onboard motion sensors comprise at least one of an accelerometer, a velocity sensor, a relative displacement sensor, and a strain gauge.

7. The method of claim 1, further comprising:
averaging the vibration data to create average vibration data;
fitting the average vibration data to preferred weighted shapes, to create a smooth fitted response shape;
extracting a resonant frequency from at least one of a fitted undamped resonant frequency and a damped resonant frequency of the smooth fitted response shape; and
calculating the remaining tread groove depth using the resonant frequency.

8. The method of claim 7, wherein calculating the remaining tread groove depth further comprises:
using an equation comprising a first quantity of the resonant frequency, a second quantity of the inflation pressure value, a third quantity of tire characterization data, and a fourth quantity of tire usage data; and
determining the remaining tread groove depth based on the first quantity, the second quantity, the third quantity, and the fourth quantity.

9. The method of claim 1, further comprising:
receiving, by the vehicle onboard computer system, a user input usage interval; and
calculating the remaining tread groove depth for the vehicle tire according to the user input usage interval.

10. The method of claim 1, further comprising:
receiving, by the vehicle onboard computer system, a request for the remaining tread groove depth; and
calculating the remaining tread groove depth, in response to the request.

11. A system for evaluating a vehicle tire mounted at a corner of a vehicle, the system comprising:
a system memory element, configured to store profile data associated with the vehicle tire, wherein the profile data comprises at least tire age data;
a plurality of vehicle onboard sensors, configured to obtain inflation pressure data for the vehicle tire and vibration data associated with the corner of the vehicle;
a display device, configured to present notifications onboard the vehicle;
at least one processor communicatively coupled to the system memory element, the display device, and the plurality of vehicle onboard sensors, the at least one processor configured to:
calculate remaining tread groove depth for the vehicle tire, based on the vibration data, the inflation pressure data, and the tire age data; and
perform a task onboard, based on the remaining tread groove depth, wherein the task comprises at least one of:
initiating presentation of a notification of the remaining tread groove depth to a driver, via the display device onboard the vehicle, and
setting code onboard the vehicle, wherein the code is associated with service notifications.

12. The system of claim 11, further comprising:
a Driver Information Center (DIC) communicatively coupled to the at least one processor, the DIC configured to:
receive a data transmission from the at least one processor, the data transmission comprising the remaining tread groove depth; and
present a notification of the remaining tread groove depth;
wherein the display device comprises the DIC.

13. The system of claim 11, further comprising:
a network interface module communicatively coupled to the at least one processor, the network interface module configured to:
receive a data transmission from the at least one processor, the data transmission comprising the remaining tread groove depth;
transmit a notification of the remaining tread groove depth to a personal electronic device, wherein the display device comprises the personal electronic device.

14. The system of claim 11, further comprising:
a user interface communicatively coupled to the system memory element and the at least one processor, the user interface configured to receive a user input time interval;
wherein the at least one processor is further configured to calculate the remaining tread groove depth for the vehicle tire according to the user input time interval.

15. The system of claim 11, further comprising:
a user interface communicatively coupled to the system memory element and the at least one processor, the user interface configured to receive a request for the remaining tread groove depth;
wherein the at least one processor is further configured to calculate the remaining tread groove depth in response to the request.

16. The system of claim 11, wherein the at least one processor is further configured to:
average the vibration data to create average vibration data;
fit the average vibration data to preferred weighting shapes, to create a smooth fitted response shape;
extract a resonant frequency from at least one of a fitted undamped resonant frequency and a damped resonant frequency of the smooth fitted response shape; and
calculate the remaining tread groove depth using the resonant frequency.

17. The system of claim 16, wherein the at least one processor is further configured to:
use an equation comprising a first quantity of the resonant frequency, a second quantity of the inflation pressure value, a third quantity of tire characterization data, and a fourth quantity of tire usage data; and
determine the remaining tread groove depth based on the resonant frequency, the first quantity, the second quantity, the third quantity, and the fourth quantity.

18. A non-transitory, computer-readable medium containing instructions thereon, which, when executed by a processor, perform a method comprising:
calculating, by a vehicle onboard computer system, remaining life of a tire mounted on a vehicle, based on vibration data associated with the tire, inflation pressure of the tire, and age of the tire; and
performing a task, based on the remaining tread groove depth for the vehicle tire, wherein the task comprises at least one of:
presenting a notification of the remaining tread groove depth to a driver, and
setting a code onboard the vehicle, wherein the code is associated with service notifications.

19. The non-transitory, computer-readable medium of claim 18, wherein the method further comprises:
averaging the vibration data to create average vibration data;
fitting the average vibration data to preferred weighted shapes, to create a smooth fitted response shape;
extracting a resonant frequency from at least one of a fitted undamped resonant frequency and a damped resonant frequency of the smooth fitted response shape; and
calculating remaining tread groove depth based on the resonant frequency, wherein the remaining life of the tire is calculated based on the remaining tread groove depth.

20. The non-transitory, computer-readable medium of claim 19, wherein the method further comprises:
using an equation to determine a first quantity of the resonant frequency, a second quantity of the inflation pressure value, a third quantity of tire characterization data, and a fourth quantity of tire usage data; and
determining the remaining tread groove depth based on the first quantity, the second quantity, the third quantity, and the fourth quantity.
